(19) United States
(12) Patent Application Publication
(10) Pub. No.: US 2024/0392992 A1
(43) Pub. Date: Nov. 28, 2024

(54) SYSTEM AND METHOD FOR MANAGING CLIMATE IN PREMISES

(71) Applicant: Carrier Corporation, Palm Beach Gardens, FL (US)

(72) Inventors: Nan Yan, Shanghai (CN); Keyu Li, Shanghai (CN); Matthew Clark, Rochester, NY (US)

(21) Appl. No.: 18/666,230

(22) Filed: May 16, 2024

Related U.S. Application Data
(60) Provisional application No. 63/504,303, filed on May 25, 2023.

(51) Int. Cl. F24F 11/63

(52) U.S. Cl. CPC F24F 11/63

(57) ABSTRACT

A system and method for managing climate in a premises is disclosed. The method includes receiving from a detection means, during a plurality of time periods, signals indicative of one or more persons within the premises; extracting from the received signals, identity of the one or more persons within the premises; receiving, from the one or more persons, respective preferred parameters for climate in the premises; predicting, based on the received signals during the plurality of time periods, presence of one or more persons in a subsequent time period, the corresponding identities of the one or more persons, and the respective preferred parameters for climate in the premises; and operating a climate control unit of the premises, such that, for the subsequent time period, the climate in the premises substantially corresponds with the respective preferred parameters for climate in the premises, of the one or more persons predicted to be in the premises.

### CROSS-REFERENCE TO RELATED APPLICATION

This patent application claims the benefit of U.S. Provisional Patent Application No. 63/504,303, filed on May 25, 2023, which is incorporated by reference herein in its entirety.

### TECHNICAL FIELD

This invention relates to managing climate in a premises, and more particularly, to efficiently operating a climate control unit of the premises.

### BACKGROUND

Climate within a premises may refer to any or a combination of comfort parameters for one or more persons within the premises, such as, without limitations, temperature, humidity, illumination, etc. A goal of a competent climate management system may be to operate various climate control systems within the premises to provide optimal and/or preferred climate conditions to one or more persons within the premises. In order to manage climate within a premises, conventional climate control systems adopt a scheduling of settings to set preferred climate parameters of one or more persons within the premises. However, such scheduling may not automatically take into consideration any variations in a number of one or more persons within the premises, or their preferred climate parameters, such as temperature, or humidity, or lighting, etc. Generally, it may be required to manually input the preferred climate parameters for each instance that there is a change in a number of one or more persons, or the one or more persons themselves. Furthermore, the scheduling may not take into consideration variations in a cost involved, such as cost of an electric power supply to operate the climate control system. As a result, the operation of the climate control system may be financially inefficient.

### SUMMARY

Disclosed herein is a method for managing climate in a premises. The method includes receiving, by a computing device, from a detection means communicably coupled to it, during a plurality of time periods, signals indicative of one or more persons within the premises. The method further includes extracting, by the computing device, from the received signals, identity of the one or more persons within the premises. The method further includes receiving, by the computing device, from the one or more persons, respective preferred parameters for climate in the premises. The method further includes predicting, by the computing device, based on the received signals during the plurality of time periods, presence of one or more persons in a subsequent time period, the corresponding identities of the one or more persons, and the respective preferred parameters for climate in the premises. The method further includes operating, by the computing device, a climate control unit of the premises communicably coupled to it, such that, for the subsequent time period, the climate in the premises substantially corresponds with the respective preferred parameters for climate in the premises, of the one or more persons predicted to be in the premises.

In one or more embodiments, the method further includes receiving, by the computing device, from a database communicably coupled to it, information pertaining to weather during the subsequent time period at a region including the premises. The method further includes determining, by the computing device, operating parameters for the climate control unit based on the information pertaining to weather and based on the respective preferred parameters for climate in the premises, of the one or more persons predicted to be in the premises.

In one or more embodiments, the method further includes receiving, by the computing device, information relating to a schedule of cost of operation of the climate control unit over a period of time. The method further includes determining, by the computing device, a time schedule for operation of the climate control unit based on the schedule of cost of operation. Operating the climate control unit is further based on the determined time schedule for operation of the climate control unit.

In one or more embodiments, the method further includes receiving, by the computing device, from electronic devices associated with one or more persons within the premises, updated preferred parameters for climate within the premises. The method further includes operating, by the computing device, the climate control unit of the premises, such that, for the subsequent time period, the climate in the premises substantially corresponds with the updated respective preferred parameters for climate in the premises.

In one or more embodiments, the method further includes determining, by the computing device, an offset defined as a deviation between the preferred parameters and updated preferred parameters for climate in the premises.

In one or more embodiments, the method further includes determining, by the computing device, one or more offsets during a subsequent plurality of time periods. The method further includes determining, by the computing device, at least one of a median and average offset from the one or more determined offsets. The method further includes predicting, by the computing device, for the subsequent time period, the updated preferred parameters for climate within the premises as a sum of the preferred parameters for climate within the premises and the at least one of the median and average offset.

In one or more embodiments, the method further includes determining, by a learning engine communicably coupled to the computing device, a trend of presence of one or more persons in the subsequent time period, the corresponding identities of the one or more persons, the respective preferred parameters for climate in the premises, and the respective updated preferred parameters for climate in the premises.

In one or more embodiments, the method further includes determining, by the computing device, a cost of operation of the climate control unit for the premises for a predefined duration of time, based on any or a combination of duration of operation of the climate control unit, the preferred parameters for the climate in the premises, the updated preferred parameters for the climate in the premises, and the schedule of cost of operation of the climate control unit over the predefined duration of time.

In one or more embodiments, the method further includes indicating, by the computing device, at an indication unit communicably coupled to it, any one or a combination of duration of operation of the climate control unit, the preferred parameters for the climate in the premises, the updated preferred parameters for the climate in the premises, and the schedule of cost of operation of the climate control unit over the predefined duration of time.

In one or more embodiments, the parameters of the climate within the premises includes any or a combination of values for temperature, humidity, lighting, and air flow.

Further disclosed herein is a system for managing climate in a premises. The system includes a detection means configured to generate signals indicative of presence of one or more persons within the premises. The system further includes a climate control unit configured to vary parameters of a climate within the premises. The system further includes a computing device communicably coupled to the detection means, and the climate control unit. The computing device is configured to receive, from the detection means, during a plurality of time periods, signals indicative of one or more persons within the premises. The computing device is further configured to extract, from the received signals, identities of the one or more persons within the premises. The computing device is further configured to receive, from the one or more persons, respective preferred parameters for climate in the premises. The computing device is further configured to predict, based on the received signals during the plurality of time periods, presence of one or more persons in a subsequent time period, the corresponding identities of the one or more persons, and the respective preferred parameters for climate in the premises. The computing device is further configured to operate the climate control unit of the premises, such that, for the subsequent time period, the climate in the premises substantially corresponds with the respective preferred parameters for climate in the premises, of the one or more persons predicted to be in the premises.

In one or more embodiments, the computing device is further configured to receive, from a database communicably coupled to the computing device, information pertaining to weather during the subsequent time period at a region including the premises. The computing device is further configured to determine operating parameters for the climate control unit based on the information pertaining to weather and based on the respective preferred parameters for climate in the premises, of the one or more persons predicted to be in the premises.

In one or more embodiments, the computing device is further configured to receive information relating to a schedule of cost of operation of the climate control unit over a period of time. The computing device is further configured to determine a time schedule for operation of the climate control unit based on the schedule of cost of operation. Operating the climate control unit is further based on the determined time schedule for operation of the climate control unit.

In one or more embodiments, the computing device is further configured to receive, from electronic devices associated with one or more persons within the premises, updated preferred parameters for climate within the premises. The computing device is further configured to operate the climate control unit of the premises, such that, for the subsequent time period, the climate in the premises substantially corresponds with the updated respective preferred parameters for climate in the premises.

In one or more embodiments, the computing device is further configured to determine an offset defined as a deviation between the preferred parameters and updated preferred parameters for climate in the premises.

In one or more embodiments, the computing device is further configured to determine one or more offsets during a subsequent plurality of time periods. The computing device is further configured to determine at least one of a median and average offset from the plurality of determined offsets. The computing device is further configured to predict, for the subsequent time period, the updated preferred parameters for climate within the premises as a sum of the preferred parameters for climate within the premises and the at least one of the median and average offset.

In one or more embodiments, the system further includes a learning engine communicably coupled to the computing device. The learning engine is configured to determine a trend of presence of one or more persons in the subsequent time period, the corresponding identities of the one or more persons, the respective preferred parameters for climate in the premises, and the respective updated preferred parameters for climate in the premises.

In one or more embodiments, the computing device is further configured to determine a cost of operation of the climate control unit for the premises for a predefined duration of time, based on any or a combination of duration of operation of the climate control unit, the preferred parameters for the climate in the premises, the updated preferred parameters for the climate in the premises, and the schedule of cost of operation of the climate control unit over the predefined duration of time.

In one or more embodiments, the computing device is further configured to indicate, at an indication unit communicably coupled to it, any one or a combination of duration of operation of the climate control unit, the preferred parameters for the climate in the premises, the updated preferred parameters for the climate in the premises, and the schedule of cost of operation of the climate control unit over the predefined duration of time.

In one or more embodiments, the parameters of the climate within the premises includes any or a combination of values for temperature, humidity, lighting, and air flow.

The foregoing summary is illustrative only and is not intended to be in any way limiting. In addition to the illustrative aspects, embodiments, and features described above, further aspects, embodiments, features, and techniques of the invention will become more apparent from the following description taken in conjunction with the drawings.

### BRIEF DESCRIPTION OF THE DRAWINGS

The accompanying drawings are included to provide a further understanding of the subject disclosure of this invention and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a schematic representation of a system for managing climate in a premises, in accordance with one or more embodiments of the invention;

FIG. 2 is a detailed schematic block diagram of a computing device of the system of FIG. 1, in accordance with one or more embodiments of the invention;

FIG. 3 is a schematic flow diagram for a method for managing climate in a premises, in accordance with one or more embodiments of the invention; and

FIG. 4 is an exemplary schematic block diagram of a hardware system used for implementing the cloud server of FIG. 2.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition one or more persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure, the components of this invention, described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components.

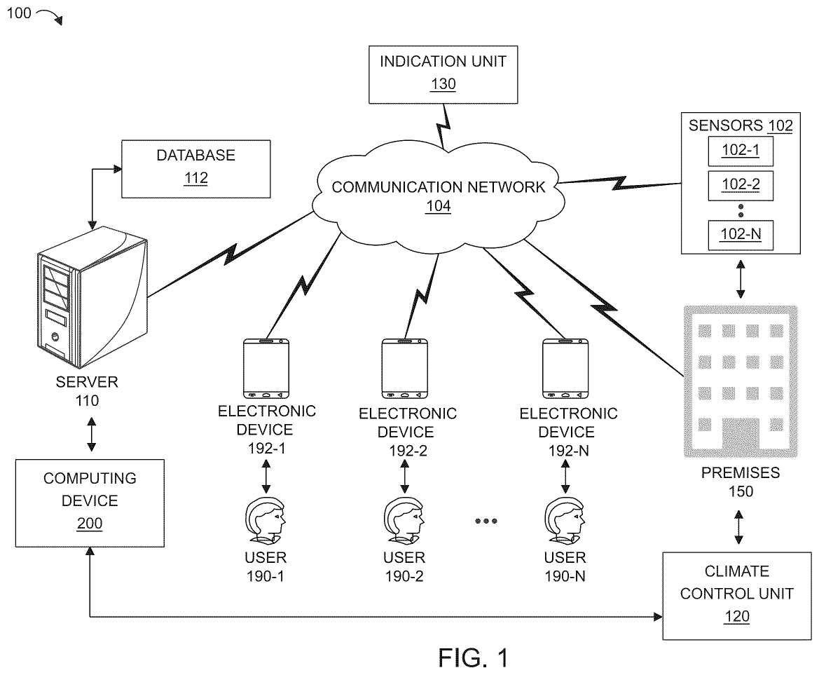

Referring to FIG. 1, a schematic representation of a system 100 for managing climate in a premises 150 is shown. In one or more embodiments, the premises 150 may refer to any structure, such as a building, an outdoor venue, etc. where one or more persons (such as persons 190) may congregate. In the illustrated embodiment, the premises 150 is a building. The building may be any, such as an office building, a residential building, public spaces, such as restaurants, malls, theaters, etc. The premises 150 may be selectively populated by one or more persons 190. In other words, there may be any number of persons 190 in the premises 150 at any given time. In one or more embodiments, the premises 150 may further be empty of any persons 190. The illustrated embodiment of FIG. 1 shows one or more persons 190-1, 190-2 . . . 190-N. The one or more persons 190-1, 190-2 . . . 190-N may be collectively interchangeably referred to as “the one or more persons 190”.

The system 100 may include a detection means to determine a presence of one or more persons 190 within the premises 150. In one or more embodiments, the means may include a plurality of sensors 102 disposed at various locations within the premises 150. The illustrated embodiment of FIG. 1 shows sensors 102-1, 102-2 . . . 102-N. The sensors 102-1, 102-2 . . . 102-N may be collectively interchangeably referred to as “the sensors 102”. The sensors 102 may be configured to generate signals indicative of presence of the one or more persons 190 in the premises 150. The sensors 102 may further generate signals indicative of their respective locations within the premises 150. In one or more embodiments, the signals generated by the sensors 102 may be a combination of signals indicative of presence of the one or more persons 190, and their respective location data. In one or more embodiments, the sensors 102 may be any or a combination of a carbon dioxide sensor, a movement sensor, a thermal sensor, an optical image sensor, etc. In one or more embodiments, the sensors 102 may be communicably coupled to one another via a communication network 104.

In one or more embodiments, the means may include a plurality of electronic devices 192 associated with the corresponding one or more persons 190. The illustrated embodiment of FIG. 1 shows electronic devices 192-1, 192-2 . . . 192-N associated with respective one or more persons 190-1, 190-2 . . . 190-N. The electronic devices 192-1, 192-2 . . . 192-N may be collectively interchangeably referred to as “the electronic devices 192”. The electronic devices 192 may include location units configured to provide information pertaining to location of the electronic devices 192, and consequently, information pertaining to location of the associated one or more persons 190. For example, location of an electronic device (e.g., 192-1) within the premises 150 may be indicative of presence of the associated person 190-1 within the premises 150.

The electronic devices 192 may be communicably coupled to the computing device 200, and other components of the system 100 through the communication network 104. In one or more embodiments, operation of the electronic devices 192 using the communication network 104 may further be indicative of a location of the electronic devices 192. For example, if an electronic device (e.g., 192-2) is using the communication network, the location of the electronic device 192-2 may be determined by triangulation.

Further, the electronic devices 192 may be used to provide input to any one or more of the components of the system 100. In some instances, the electronic devices 192 may include audio-visual devices, such as display screens, LED lighting displays, speakers, etc. The electronic devices 192 may be any electrical, electronic, electromechanical, or computing device. The electronic devices 192 may include, without limitations, a mobile device, a smart phone, a Personal Digital Assistant (PDA), a tablet computer, a phablet computer, a wearable device, a Virtual Reality/Augment Reality (VR/AR) device, a laptop, a desktop, and the like.

The electronic devices 192 may be configured to execute a set of instructions to generate an interface to exchange data with other components of the system 100. The set of instructions may result in opening of an application or a software. In some cases, executing the set of instruction may result in opening of an application hosted on an external server, such as a website. In one or more embodiments, the electronic devices 192 may be configured to request the associated one or more persons 190 to provide inputs relating to parameters of the climate, such as preferred climate parameters or updated climate parameters. The parameters of the climate may include, without limitations, any, or a combination of values for temperature, humidity, lighting, and air flow.

In one or more embodiments, the communication network 104 may be a wireless communication network. The wireless communication network may be any wireless communication network capable of transferring data between entities of that network such as, without limitations, a carrier network including circuit switched network, a public switched network, a Content Delivery Network (CDN) network, a Long-Term Evolution (LTE) network, a Global System for Mobile Communications (GSM) network and a Universal Mobile Telecommunications System (UMTS) network, an Internet, intranets, local area networks, wide area networks, mobile communication networks, Bluetooth low energy (BLE) networks, and combinations thereof. Through the communication network 104, the sensors 102 may be configured to transmit signals to each other or to an external device.

In one or more embodiments, the communication network 104 may be a hardwired communication network. The hardwired communication network may be an optic cable, or a metallic cable provided in the structure of the premises 150 in which the sensors 102 are disposed.

The system 100 further includes a server 110. The detection means may be communicably coupled to the server 110. In one or more embodiments, the server 110 may be a remote server. In one or more embodiments, the server 110 may be a cloud-based server. The server 110 may further be communicably coupled to a database 112 through the communication network 104. The database 112 may be configured within the server 110 or may be a cloud-based storage device.

The server 110 may be configured with a computing device 200. The computing device 200 may be configured for managing climate in the premises 150. The computing device 200 may be implemented by way of a single device or a combination of multiple devices that may be communicably coupled or networked together. The computing device 200 may be implemented in hardware or a suitable combination of hardware and software. The computing device 200 may be a hardware device including a processor executing machine-readable program instructions. The “hardware” may include a combination of discrete components, an integrated circuit, an application-specific integrated circuit, a field programmable gate array, a digital signal processor, or other suitable hardware. The “software” may include one or more objects, agents, threads, lines of code, subroutines, separate software applications, two or more lines of code or other suitable software structures operating in one or more software applications or on one or more processors. The processor may include, for example, without limitations, microprocessors, microcomputers, microcontrollers, digital signal processors, central processing units, state machines, logic circuits, any devices that manipulate data or signals based on operational instructions, and the like. Among other capabilities, the processor may fetch and execute computer-readable instructions in the memory operationally coupled with the computing device 200 for performing tasks such as data processing, input/output processing, feature extraction, and/or any other functions. Any reference to a task in the present disclosure may refer to an operation being or that may be performed on data.

The system 100 further includes a climate control unit 120. The climate control unit 120 may be operable by the computing device 200. The climate control unit 120 may be configured to operate various devices and/or apparatuses configured within the premises 150 that are configured to control a climate within the premises 150. The devices and/or apparatuses may include, without limitations, HVAC systems, thermal regulation systems, thermal control systems, illumination systems, fans and/or blowers, etc.

The system 100 further includes an indication unit 130 configured to indicate information to the one or more persons 190 within the premises 150. The indication unit 130 may include units, such as, without limitations, a display unit, an audio unit, a notification unit, an input unit, an output unit, and the like; however, the same are not shown in the FIG. 1, for the purpose of clarity.

In order to manage climate within a premises, conventional climate control systems adopt a scheduling of settings to set preferred climate parameters of one or more persons within the premises. However, such scheduling may not automatically take into consideration any variations in a number of one or more persons within the premises, or their preferred climate parameters, such a s temperature, or humidity, or illumination, etc. Generally, it may be required to manually input the preferred climate parameters for each instance that there is a change in a number of one or more persons, or the one or more persons themselves. Furthermore, the scheduling may not take into consideration variations in a cost involved, such as cost of an electric power supply to operate the climate control system. As a result, the operation of the climate control system may be financially inefficient.

Thus, there is a requirement for a means to anticipate or predict movement or presence of one or more persons within a premises, and to provide optimal climate conditions within the premises for when the one or more persons are within it. Further, there is a requirement for a means to effectively operate a climate control within the premises to make it financially more efficient.

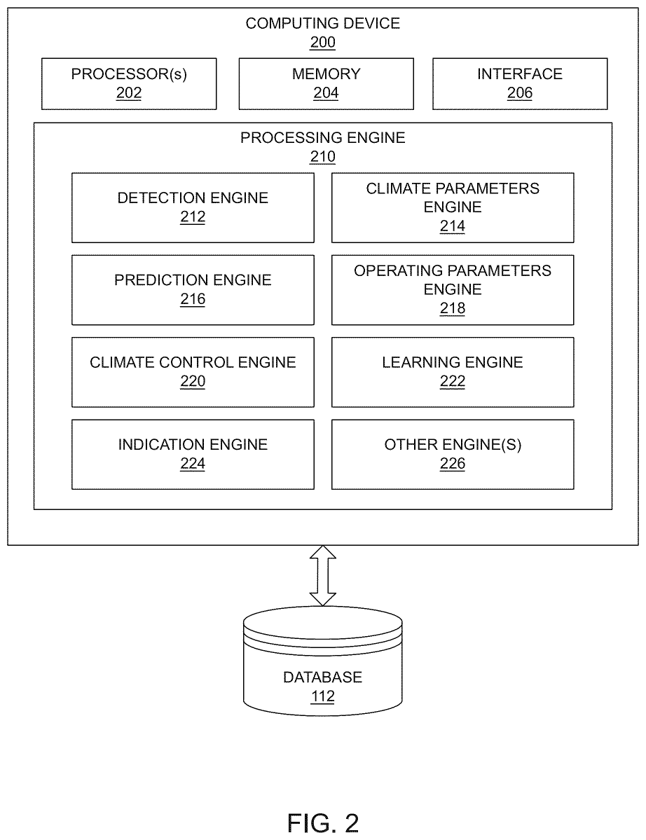

Referring to FIG. 2, a detailed schematic block diagram of the computing device 200 is shown. The computing device 200 includes a processor 202, and a memory 204 communicably coupled to the processor 202. The memory 204 may store instructions executable by the processor 202 to implement the computing device 200. The computing device 200 further includes an interface 206. The interface 206 may include a variety of interfaces, for example, interfaces for data input and output devices, referred to as I/O devices, storage devices, and the like. The interface 206 may also provide a communication pathway for one or more components of the computing device 200. The computing device 200 is communicably coupled to the database 112 (also shown in FIG. 1). The database 112 may be configured to store data generated during execution of instructions by the processor 202 in order to implement the computing device 200. The database 112 may further be configured to store additional data required for implementing the computing device 200.

Referring now to FIGS. 1 and 2, in one or more embodiments, the computing device 200 includes a processing engine 210. The processing engine 210 may be implemented as a combination of hardware and programming (for example, programmable instructions) to implement one or more functionalities of the processing engine 210. In some examples, the processing engine 210 may be implemented by electronic circuitry.

The processing engine 210 may include a detection engine 212, a climate parameters engine 214, a prediction engine 216, an operating parameters engine 218, a climate control engine 220, a learning engine 222, an indication engine 224, and other engine(s) 226. The other engine(s) 226 may include engines configured to perform one or more functions ancillary functions associated with the processing engine 210.

The detection engine 212 is configured to receive, from the detection means, during a plurality of time periods, signals indicative of one or more persons 190 within the premises 150. The detection engine 212 is further configured to extract, from the received signals identity of the one or more persons 190 within the premises 150. In one or more embodiments, the plurality of time periods may be a plurality of instances during which the processing engine 210 may receive samples of presence of one or more persons 190 within the premises 150 in order to determine a trend of presence of one or more persons. In one or more embodiments, the detection engine 212 may receive this input from the one or more persons 190 through the associated electronic device 192. In some other embodiments, the detection engine 212 may receive this input from the learning engine 222.

The climate parameters engine 214 is configured to receive, from the one or more persons 190, respective preferred parameters for climate in the premises 150. In one or more embodiments, the parameters of the climate within the premises may include, without limitations, any, or a combination of values for temperature, humidity, lighting, and air flow.

The prediction engine 216 is configured to predict, based on the received signals during the plurality of time periods, presence of one or more persons in a subsequent time period, the corresponding identities of the one or more persons, and the respective preferred parameters for climate in the premises. In other words, the prediction engine 216 is configured to determine an occupancy within the premises 150 during a future instance, based on a trend of occupancies, as determined by the detection engine 212.

The operating parameters engine 218 is configured to determine operating parameters for the climate control unit 120, such that, responsive to operation of the climate control unit 120, for the subsequent time period, the climate in the premises 150 substantially corresponds with the respective preferred parameters for climate in the premises 150, of the one or more persons 190 predicted to be in the premises 150. The operating parameters may be any or a combination of electric power, duration, etc. for which various devices and/or apparatuses in the premises 150 are to be operated in order to achieve and maintain the respective preferred climate for any one or more persons predicted to be in the premises 150 in the subsequent period of time.

In one or more embodiments, the operating parameters engine 218 may receive, from the database 112, information pertaining to weather during the subsequent time period at a region where the premises 150 may be situated. The operating parameters engine 218 is then configured to determine the operating parameters for the climate control unit 120 based on the information pertaining to weather and based on the respective preferred parameters for climate in the premises 150, of the one or more persons 190 predicted to be in the premises 150. In other words, the operating parameters engine 218 may consider weather conditions, along with preferred climate parameters of the one or more persons 190 in order to determine operating parameters. For example, if the weather is very cold, the operating parameters may include longer duration of operation or higher intensity of operation of a temperature control unit in order to increase a temperature within the premises 150.

In one or more embodiments, the operating parameters engine 218 may further be configured to receive information relating to a schedule of cost of operation of the climate control unit 120 over a period of time. For example, the operating parameters engine 218 may receive a schedule of charges for an electric power supply, and its variation through a period of time, such as a day. The operating parameters engine 218 may be further configured to determine a time schedule for operation of the climate control unit 120 based on the schedule of cost of operation. Further, the operating parameters engine 218 may determine the time schedule for operation of the climate control unit 120 to minimize a cost of operation of the climate control unit 120. For example, the operating parameters engine 218 may determine that during a certain period in a day, when electric power charges are minimum, the climate control unit 120 may be run at a higher intensity in order to achieve a preferred climate within the premises 150. Thus, the operating parameters engine 218 may manage climate within the premises 150 in a manner that is financially efficient. The operation of the climate control unit 120 may be further based on the determined time schedule for operation of the climate control unit 120. In other words, the operating parameters engine 218 may be configured to ensure that preferred climate conditions are achieved, irrespective of costs involved.

The climate control engine 220 is configured to operate the climate control unit 120 based on the determined operating parameters, such that, for the subsequent time period, the climate in the premises 150 substantially corresponds with the respective preferred parameters for climate in the premises 150, of the one or more persons 190 predicted to be in the premises 150.

In one or more embodiments, the climate parameters engine 214 may be configured to receive, from electronic devices 192 associated with one or more persons 190 within the premises 150, updated preferred parameters for climate within the premises 150. This may occur when there may be a change in requirement by the one or more persons 190 from what the prediction engine 216 may have predicted their preferred climate parameters to be. In such an instance, the operating parameters engine 218 may be configured to determine operating parameters for the climate control unit 120, such that, for the subsequent time period, the climate in the premises 150 substantially corresponds with the updated respective preferred parameters for climate in the premises 150, of the one or more persons 190 predicted to be in the premises 150.

In one or more embodiments, the operating parameters engine 218 may be further configured to determine an offset, defined as a deviation between the preferred parameters and updated preferred parameters for climate in the premises 150.

In one or more embodiments, the learning engine 222 is configured to determine a trend of presence of one or more persons 190 in the subsequent time period, the corresponding identities of the one or more persons 190, the respective preferred parameters for climate in the premises 150, and the respective updated preferred parameters for climate in the premises 150.

In one or more embodiments, the learning engine 222 is further configured to receive, from the operating parameters engine 218, one or more offsets during a subsequent plurality of time periods. The learning engine 222 may be further configured to determine at least one of a median and average offset from the plurality of determined offsets. The learning engine 222 may be further configured to predict, for the subsequent time period, the updated preferred parameters for climate within the premises as a sum of the preferred parameters for climate within the premises and the at least one of the median and average offset.

The learning engine 222 may be configured to provide the predicted updated parameters to the climate parameters engine 214, and the operating parameters engine 218 may determine operating parameters for the climate control unit 120 based on this input.

In one or more embodiments, learning engine 222 may further be configured to determine a cost of operation of the climate control unit 120 for the premises for a predefined duration of time, based on any or a combination of duration of operation of the climate control unit 120, the preferred parameters for the climate in the premises, the updated preferred parameters for the climate in the premises, and the schedule of cost of operation of the climate control unit 120 over the predefined duration of time. In one or more embodiments, the learning engine 222 may be trained on a plurality of such data sets from the plurality of time durations.

In one or more embodiments, the learning engine 222 may include an energy forecast model configured to determine an energy requirement for the premises based on historical requirements of the energy for the premises for operation of the climate control unit 120.

In one or more embodiments, the indication engine 224 is further configured to indicate, at the indication unit 130, any one or a combination of duration of operation of the climate control unit 120, the preferred parameters for the climate in the premises, the updated preferred parameters for the climate in the premises, and the schedule of cost of operation of the climate control unit 120 over the predefined duration of time.

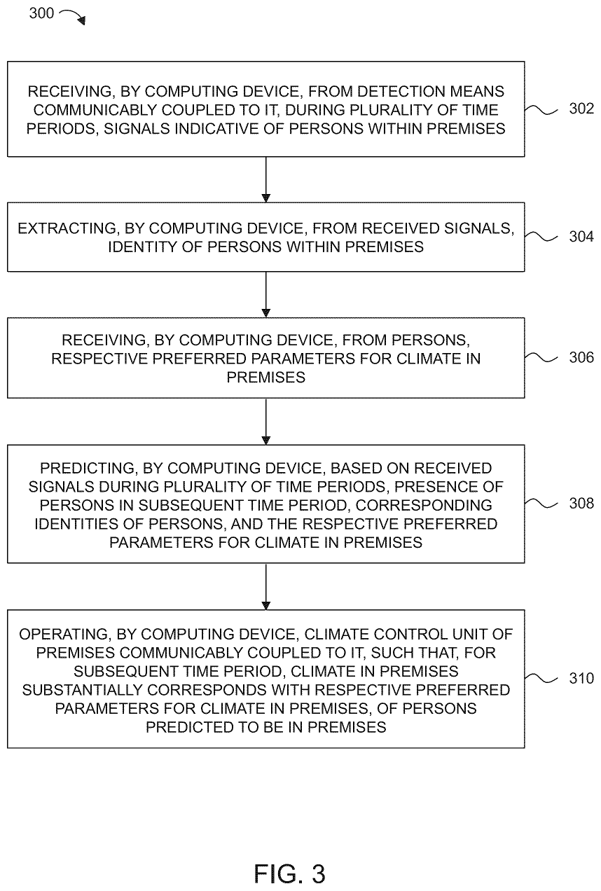

Referring to FIG. 3, a schematic flow diagram for a method 300 for managing climate in a premises 150 is shown. Referring now to FIGS. 1 to 3, at step 302, the method 300 includes receiving, by the computing device 200, from the detection means communicably coupled to it, during the plurality of time periods, signals indicative of one or more persons 190 within the premises 150. At step 304, the method 300 further includes extracting, by the computing device 200, from the received signals, identity of the one or more persons 190 within the premises 150. At step 306, the method 300 further includes receiving, by the computing device 200, from the one or more persons 190, respective preferred parameters for climate in the premises 150. At step 308, the method 300 further includes predicting, by the computing device 200, based on the received signals during the plurality of time periods, presence of one or more persons 190 in a subsequent time period, the corresponding identities of the one or more persons 190, and the respective preferred parameters for climate in the premises 150. At step 310, the method 300 further includes operating, by the computing device 200, the climate control unit 120 of the premises 150 communicably coupled to it, such that, for the subsequent time period, the climate in the premises 150 substantially corresponds with the respective preferred parameters for climate in the premises 150, of the one or more persons 190 predicted to be in the premises 150.

In one or more embodiments, the method 300 further includes receiving, by the computing device 200, from the database 112 communicably coupled to it, information pertaining to weather during the subsequent time period at a region including the premises 150. The method 300 further includes determining, by the computing device 200, operating parameters for the climate control unit 120 based on the information pertaining to weather and based on the respective preferred parameters for climate in the premises 150, of the one or more persons 190 predicted to be in the premises 150.

In one or more embodiments, the method 300 further includes receiving, by the computing device 200, information relating to a schedule of cost of operation of the climate control unit 120 over a period of time. The method 300 further includes determining, by the computing device 200, a time schedule for operation of the climate control unit 120 based on the schedule of cost of operation. Operation of the climate control unit 120 is further based on the determined time schedule for operation of the climate control unit 120.

In one or more embodiments, the method 300 further includes receiving, by the computing device 200, from electronic devices 192 associated with one or more persons 190 within the premises 150, updated preferred parameters for climate within the premises 150. The method 300 further includes operating, by the computing device 200, the climate control unit 120 of the premises 150, such that, for the subsequent time period, the climate in the premises 150 substantially corresponds with the updated respective preferred parameters for climate in the premises 150.

In one or more embodiments, the method 300 further includes determining, by the computing device 200, the offset defined as a deviation between the preferred parameters and updated preferred parameters for climate in the premises 150.

In one or more embodiments, the method 300 further includes determining, by the computing device 200, one or more offsets during the subsequent plurality of time periods. The method 300 further includes determining, by the computing device 200, at least one of the median and average offset from the one or more determined offsets. The method 300 further includes predicting, by the computing device 200, for the subsequent time period, the updated preferred parameters for climate within the premises 150 as a sum of the preferred parameters for climate within the premises 150 and the at least one of the median and average offset.

In one or more embodiments, the method 300 further includes determining, by the learning engine 222 communicably coupled to the computing device 200, the trend of presence of one or more persons 190 in the subsequent time period, the corresponding identities of the one or more persons 190, the respective preferred parameters for climate in the premises 150, and the respective updated preferred parameters for climate in the premises 150.

In one or more embodiments, the method 300 further includes determining, by the computing device 200, the cost of operation of the climate control unit 120 for the premises 150 for a predefined duration of time, based on any or a combination of duration of operation of the climate control unit 120, the preferred parameters for the climate in the premises 150, the updated preferred parameters for the climate in the premises 150, and the schedule of cost of operation of the climate control unit 120 over the predefined duration of time.

In one or more embodiments, the method 300 further includes indicating, by the computing device 200, at an indication unit 130 communicably coupled to it, any one or a combination of duration of operation of the climate control unit 120, the preferred parameters for the climate in the premises 150, the updated preferred parameters for the climate in the premises 150, and the schedule of cost of operation of the climate control unit 120 over the predefined duration of time.

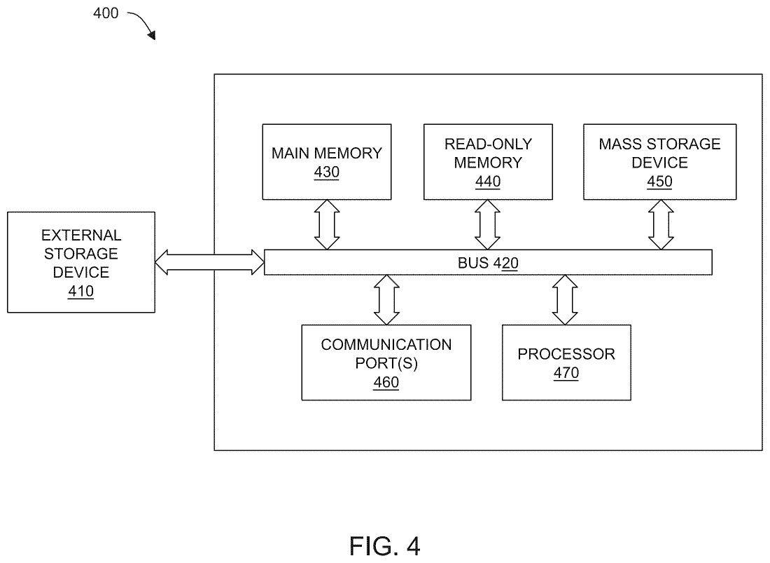

FIG. 4 is an exemplary schematic block diagram of a hardware system used for implementing the computing device 200. As shown in FIG. 4, a computer system 400 can include a database 410, a bus 420, a main memory 430, a read only memory 440, a mass storage device 450, communication port 460, and a processor 470. A person skilled in the art will appreciate that the computer system may include more than one processor and communication ports. Examples of processor 470 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 470 may include various modules. Communication port 460 can be any of an RS-232 port for use with a modem-based dialup connection, a 10/100 Ethernet port, a Gigabit or 10 Gigabit port using copper or fibre, a serial port, a parallel port, or other existing or future ports. Communication port 460 may be chosen depending on a network, such a Local Area Network (LAN), Wide Area Network (WAN), or any network to which computer system connects. Memory 430 can be Random Access Memory (RAM), or any other dynamic storage device commonly known in the art. Read-only memory 440 can be any static storage device(s) e.g., but not limited to, a Programmable Read Only Memory (PROM) chips for storing static information e.g., start-up or BIOS instructions for processor 470. Mass storage 450 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 420 communicatively couples processor(s) 470 with the other memory, storage, and communication blocks. Bus 420 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 470 to software system.

Optionally, operator and administrative interfaces, e.g., a display, keyboard, and a cursor control device, may also be coupled to bus 420 to support direct operator interaction with a computer system. Other operator and administrative interfaces can be provided through network connections connected through communication port 460. The database 410 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

While the invention has been described with reference to exemplary embodiments, it will be understood by those skilled in the art that various changes may be made and equivalents may be substituted for elements thereof without departing from the scope of the invention as defined by the appended claims. Modifications may be made to adopt a particular situation or material to the teachings of the invention without departing from the scope thereof. Therefore, it is intended that the invention not be limited to the particular embodiment disclosed, but that the invention includes all embodiments falling within the scope of the invention as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A method for managing climate in a premises, the method comprising:
receiving, by a computing device, from a detection means communicably coupled to it, during a plurality of time periods, signals indicative of one or more persons within the premises;
extracting, by the computing device, from the received signals, identity of the one or more persons within the premises;
receiving, by the computing device, from the one or more persons, respective preferred parameters for climate in the premises;
predicting, by the computing device, based on the received signals during the plurality of time periods, presence of one or more persons in a subsequent time period, the corresponding identities of the one or more persons, and the respective preferred parameters for climate in the premises; and
operating, by the computing device, a climate control unit of the premises communicably coupled to it, such that, for the subsequent time period, the climate in the premises substantially corresponds with the respective preferred parameters for climate in the premises, of the one or more persons predicted to be in the premises.

2. The method of claim 1, further comprising:
receiving, by the computing device, from a database communicably coupled to it, information pertaining to weather during the subsequent time period at a region comprising the premises; and
determining, by the computing device, operating parameters for the climate control unit based on the information pertaining to weather and based on the respective preferred parameters for climate in the premises, of the one or more persons predicted to be in the premises.

3. The method of claim 1, further comprising:
receiving, by the computing device, information relating to a schedule of cost of operation of the climate control unit over a period of time; and
determining, by the computing device, a time schedule for operation of the climate control unit based on the schedule of cost of operation,
wherein operating the climate control unit is further based on the determined time schedule for operation of the climate control unit.

4. The method of claim 1, further comprising:
receiving, by the computing device, from electronic devices associated with one or more persons within the premises, updated preferred parameters for climate within the premises; and
operating, by the computing device, the climate control unit of the premises, such that, for the subsequent time period, the climate in the premises substantially corresponds with the updated respective preferred parameters for climate in the premises.

5. The method of claim 4, further comprising determining, by the computing device, an offset defined as a deviation between the preferred parameters and updated preferred parameters for climate in the premises.

6. The method of claim 5, further comprising:
determining, by the computing device, one or more offsets during a subsequent plurality of time periods;
determining, by the computing device, at least one of a median and average offset from the one or more determined offsets; and
predicting, by the computing device, for the subsequent time period, the updated preferred parameters for climate within the premises as a sum of the preferred parameters for climate within the premises and the at least one of the median and average offset.

7. The method of claim 1, further comprising determining, by a learning engine communicably coupled to the computing device, a trend of presence of one or more persons in the subsequent time period, the corresponding identities of the one or more persons, the respective preferred parameters for climate in the premises, and the respective updated preferred parameters for climate in the premises.

8. The method of claim 1, further comprising determining, by the computing device, a cost of operation of the climate control unit for the premises for a predefined duration of time, based on any or a combination of duration of operation of the climate control unit, the preferred parameters for the climate in the premises, the updated preferred parameters for the climate in the premises, and the schedule of cost of operation of the climate control unit over the predefined duration of time.

9. The method of claim 1, further comprising indicating, by the computing device, at an indication unit communicably coupled to it, any one or a combination of duration of operation of the climate control unit, the preferred parameters for the climate in the premises, the updated preferred parameters for the climate in the premises, and the schedule of cost of operation of the climate control unit over the predefined duration of time.

10. The method of claim 1, wherein the parameters of the climate within the premises comprises any or a combination of values for temperature, humidity, lighting, and air flow.

11. A system for managing climate in a premises, the system comprising:
a detection means configured to generate signals indicative of presence of one or more persons within the premises;
a climate control unit configured to vary parameters of a climate within the premises; and
a computing device communicably coupled to the detection means, and the climate control unit, the computing device configured to:
receive, from the detection means, during a plurality of time periods, signals indicative of one or more persons within the premises;
extract, from the received signals, identities of the one or more persons within the premises;
receive, from the one or more persons, respective preferred parameters for climate in the premises;
predict, based on the received signals during the plurality of time periods, presence of one or more persons in a subsequent time period, the corresponding identities of the one or more persons, and the respective preferred parameters for climate in the premises; and
operate the climate control unit of the premises, such that, for the subsequent time period, the climate in the premises substantially corresponds with the respective preferred parameters for climate in the premises, of the one or more persons predicted to be in the premises.

12. The system of claim 11, wherein the computing device is further configured to:
receive, from a database communicably coupled to the computing device, information pertaining to weather during the subsequent time period at a region comprising the premises; and
determine operating parameters for the climate control unit based on the information pertaining to weather and based on the respective preferred parameters for climate in the premises, of the one or more persons predicted to be in the premises.

13. The system of claim 11, wherein the computing device is further configured to:
receive information relating to a schedule of cost of operation of the climate control unit over a period of time; and
determine a time schedule for operation of the climate control unit based on the schedule of cost of operation,
wherein operating the climate control unit is further based on the determined time schedule for operation of the climate control unit.

14. The system of claim 11, wherein the computing device is further configured to:
receive, from electronic devices associated with one or more persons within the premises, updated preferred parameters for climate within the premises; and
operate the climate control unit of the premises, such that, for the subsequent time period, the climate in the premises substantially corresponds with the updated respective preferred parameters for climate in the premises.

15. The system of claim 14, wherein the computing device is further configured to determine an offset defined as a deviation between the preferred parameters and updated preferred parameters for climate in the premises.

16. The system of claim 15, wherein the computing device is further configured to:
determine one or more offsets during a subsequent plurality of time periods;
determine at least one of a median and average offset from the one or more determined offsets; and
predict, for the subsequent time period, the updated preferred parameters for climate within the premises as a sum of the preferred parameters for climate within the premises and the at least one of the median and average offset.

17. The system of claim 11, further comprising a learning engine communicably coupled to the computing device, wherein the learning engine is configured to determine a trend of presence of one or more persons in the subsequent time period, the corresponding identities of the one or more persons, the respective preferred parameters for climate in the premises, and the respective updated preferred parameters for climate in the premises.

18. The system of claim 11, wherein the computing device is further configured to determine a cost of operation of the climate control unit for the premises for a predefined duration of time, based on any or a combination of duration of operation of the climate control unit, the preferred parameters for the climate in the premises, the updated preferred parameters for the climate in the premises, and the schedule of cost of operation of the climate control unit over the predefined duration of time.

19. The system of claim 11, wherein the computing device is further configured to indicate, at an indication unit communicably coupled to it, any one or a combination of duration of operation of the climate control unit, the preferred parameters for the climate in the premises, the updated preferred parameters for the climate in the premises, and the schedule of cost of operation of the climate control unit over the predefined duration of time.

20. The system of claim 11, wherein the parameters of the climate within the premises comprises any or a combination of values for temperature, humidity, lighting, and air flow.
